(19) United States
(12) Patent Application Publication
(10) Pub. No.: US 2008/0194769 A1
(43) Pub. Date: Aug. 14, 2008

(54) Process for coagulating fluoroelastomers

(76) Inventor: Donald F. Lyons, Wilmington, DE (US)

Correspondence Address: DUPONT PERFORMANCE ELASTOMERS L.L.C., PATENT RECORDS CENTER, 4417 LANCASTER PIKE, BARLEY MILL PLAZA P25, WILMINGTON, DE, 19805, US

(21) Appl. No.: 12/009,270

(22) Filed: Jan. 17, 2008

Related U.S. Application Data
(60) Provisional application No. 60/900,264, filed on Feb. 8, 2007.

(51) Int. Cl. C08F 14/22

(52) U.S. Cl. 525/384; 526/255

(57) ABSTRACT

In a process for the manufacture of fluoroelastomers, a coagulant is employed that is a water-soluble polymer having at least 2 quaternary onium centers. Specific examples of such coagulants include, but are not limited to poly(diallyldimethylammonium chloride), poly(epichlorohydrin-co-dimethyl amine), and poly(acrylamide-co-diallyldimethylammonium chloride).

### CROSS-REFERENCE TO RELATED APPLICATIONS

This application claims the benefit of U.S. Provisional Application No. 60/900,264 filed Feb. 8, 2007.

### FIELD OF THE INVENTION

This invention pertains to a novel process for the coagulation of fluoroelastomers wherein a certain class of cationic polymers is employed as the coagulating agent, more particularly a water-soluble polymer having at least two quaternary onium centers is employed as coagulating agent.

### BACKGROUND OF THE INVENTION

Elastomeric copolymers of vinylidene fluoride having excellent heat resistance, oil resistance, and chemical resistance have been used widely for sealing materials, containers and hoses.

Production of such fluoroelastomers by emulsion polymerization methods is well known in the art; see for example U.S. Pat. Nos. 4,214,060 and 4,281,092. The result of the polymerization is a dispersion or latex of the polymer. Generally, fluoroelastomers are then separated from the dispersion by addition of a coagulant to form a slurry. The slurry is then washed and dried and then shaped into final form for commercial use.

Coagulants heretofore employed are typically salts of inorganic multivalent cations, A. L. Logothetis, Prog. Polym. Sci, 14, 251-296 (1989). These include aluminum salts such as aluminum sulfate, alums such as potassium aluminum sulfate, calcium salts such as calcium chloride and calcium nitrate, and magnesium salts such as magnesium chloride and magnesium nitrate. While these salts work very well as coagulants, residual amounts of these salts remain in the polymer. The presence of these salts renders the polymers unsuitable for use in contamination-sensitive applications such as seals in semiconductor manufacture. Thus, it would be desirable to find other coagulants effective for use in the emulsion polymerization of fluoroelastomers.

Salts of univalent cations, such as sodium chloride, have been proposed as coagulating agents for the manufacture of fluoroelastomers. Residual amounts of these salts are considered relatively innocuous in some end use applications. However, excessively large amounts of salts of univalent cations are required to fully coagulate the fluoroelastomer. The resulting polymer is difficult to fully dry In addition, the large quantity of these salts that is needed to coagulate the polymer requires large and expensive water treatment facilities.

The use of organic coagulants is another method to avoid polymer contamination. Residual amounts of organic coagulants will not contaminate semiconductor processes and, in some instances, may volatilize out of the polymer during the curing process. U.S. Pat. No. 3,598,794 discloses polyamines as coagulants for fluoroelastomers. Addition of a polyamine to a fluoroelastomer dispersion forms a gel that can be separated from the aqueous phase. Washing of this gel, however, is difficult and residual polyamine that remains in the fluoroelastomer interferes in the curing operation.

U.S. Pat. No. 3,997,705 discloses coagulation of a fluoroelastomer with an organic base or salt that acts as a vulcanization accelerator. However, the use of such a coagulant results in a fluoroelastomer that is subject to premature cure or scorch. In addition, the use of such a coagulant restricts the options for subsequent compounding of the fluoroelastomer, since an accelerator is already present in the polymer.

WO 2005/066218 A1 discloses a process for the coagulation of perfluoroelastomers wherein an onium compound is employed as a coagulating agent. Suitable onium compounds are said to include those previously described as catalysts or curatives useful in fluoroelastomer compositions.

### SUMMARY OF THE INVENTION

Surprisingly, it has been found that certain organic cationic polymers may be used to coagulate fluoroelastomers without resulting in a gel and without causing the elastomers to cure prematurely. One aspect of the present invention provides a coagulation process for the production of fluoroelastomers, said fluoroelastomers having at least 53 weight percent fluorine, said process comprising:

(A) providing an aqueous dispersion comprising a fluoroelastomer, said fluoroelastomer comprising copolymerized units of at least two copolymerizable monomers wherein a first monomer is present in an amount between 25 and 70 weight percent, based on total weight of said fluoroelastomer, said first monomer selected from the group consisting of vinylidene fluoride and tetrafluoroethylene; and

(B) adding to said aqueous dispersion an aqueous solution of a water-soluble polymer comprising at least 2 quaternary onium centers thereby coagulating said fluoroelastomer.

Another aspect of the invention is a fluoroelastomer made by a process comprising:

(A) providing an aqueous dispersion comprising a fluoroelastomer, said fluoroelastomer comprising copolymerized units of at least two copolymerizable monomers wherein a first monomer is present in an amount between 25 and 70 weight percent, based on total weight of said fluoroelastomer, said first monomer selected from the group consisting of vinylidene fluoride and tetrafluoroethylene; and

(B) adding to said aqueous dispersion an aqueous solution of a water-soluble polymer having at least 2 quaternary onium centers thereby coagulating said fluoroelastomer.

Another aspect of the invention is a curable composition comprising:

(A) a polyhydroxy curative; and

(B) a fluoroelastomer made by a process comprising

(i) providing an aqueous dispersion comprising a fluoroelastomer, said fluoroelastomer comprising copolymerized units of at least two copolymerizable monomers wherein a first monomer is present in an amount between 25 and 70 weight percent, based on total weight of said fluoroelastomer, said first monomer selected from the group consisting of vinylidene fluoride and tetrafluoroethylene; and

(ii) adding to said aqueous dispersion an aqueous solution of a water-soluble polymer having at least 2 quaternary onium centers thereby coagulating said fluoroelastomer.

### DETAILED DESCRIPTION OF THE INVENTION

The present invention is directed to a coagulation process for producing a fluoroelastomer and to fluoroelastomers and curable compositions produced therefrom. By “fluoroelastomer” is meant an amorphous elastomeric fluoropolymer. The fluoropolymer may be partially fluorinated or perfluorinated, so long as it contains at least 53 percent by weight fluorine, preferably at least 64 wt. % fluorine. Fluoroelastomers made by the process of this invention contain between 25 to 70 weight percent, based on the total weight of the fluoroelastomer, of copolymerized units of a first monomer which may be vinylidene fluoride (VF₂) or tetrafluoroethylene (TFE). The remaining units in the fluoroelastomers are comprised of one or more additional copolymerized monomers, different from said first monomer, selected from the group consisting of fluorine-containing olefins, fluorine-containing vinyl ethers, hydrocarbon olefins and mixtures thereof.

According to the present invention, fluorine-containing olefins copolymerizable with the first monomer include, but are not limited to, vinylidene fluoride, hexafluoropropylene (HFP), tetrafluoroethylene (TFE), 1,2,3,3,3-pentafluoropropene (1-HPFP), chlorotrifluoroethylene (CTFE) and vinyl fluoride.

The fluorine-containing vinyl ethers employed in the present invention include, but are not limited to perfluoro(alkyl vinyl)ethers. Perfluoro(alkyl vinyl)ethers (PAVE) suitable for use as monomers include those of the formula

CF₂═CFO(R_{f′}O)ₙ(R_{f″}O)ₘR_{f} (I)

where R_{f′} and R_{f″} are different linear or branched perfluoroalkylene groups of 2-6 carbon atoms, m and n are independently 0-10, and R_{f} is a perfluoroalkyl group of 1-6 carbon atoms.

A preferred class of perfluoro(alkyl vinyl)ethers includes compositions of the formula

CF₂═CFO(CF₂CFXO)ₙR_{f} (II)

where X is F or CF₃, n is 0-5, and R_{f} is a perfluoroalkyl group of 1-6 carbon atoms.

A most preferred class of perfluoro(alkyl vinyl)ethers includes those ethers wherein n is 0 or 1 and R_{f} contains 1-3 carbon atoms. Examples of such perfluorinated ethers include perfluoro(methyl vinyl)ether (PMVE) and perfluoro(propyl vinyl)ether (PPVE). Other useful monomers include compounds of the formula

CF₂═CFO[(CF₂)ₘCF₂CFZO]ₙR_{f} (III)

where R_{f} is a perfluoroalkyl group having 1-6 carbon atoms, m=0 or 1, n=0-5, and Z=F or CF₃. Preferred members of this class are those in which R_{f} is C₃F₇, m=0, and n=1.

Additional perfluoro(alkyl vinyl)ether monomers include compounds of the formula

CF₂═CFO[(CF₂CF{CF₃}O)ₙ(CF₂CF₂CF₂O)ₘ(CF₂)ₚ]CₓF₂ₓ₊₁ (IV)

where m and n independently=0-10, p=0-3, and x=1-5. Preferred members of this class include compounds where n=0-1, m=0-1, and x=1.

Other examples of useful perfluoro(alkyl vinyl ethers) include

CF₂═CFOCF₂CF(CF₃)O(CF₂O)ₘCₙF₂ₙ₊₁ (V)

where n=1-5, m=1-3, and where, preferably, n=1.

If copolymerized units of PAVE are present in fluoroelastomers prepared by the process of the invention, the PAVE content generally ranges from 25 to 75 weight percent, based on the total weight of the fluoroelastomer. If perfluoro(methyl vinyl)ether is used, then the fluoroelastomer preferably contains between 30 and 55 wt. % copolymerized PMVE units.

Hydrocarbon olefins useful in the fluoroelastomers prepared by the process of this invention include, but are not limited to ethylene (E) and propylene (P). If copolymerized units of a hydrocarbon olefin are present in the fluoroelastomers prepared by the process of this invention, hydrocarbon olefin content is generally 4 to 30 weight percent

The fluoroelastomers prepared by the process of the present invention may also, optionally, comprise units of one or more cure site monomers. Examples of suitable cure site monomers include: i) bromine-containing olefins; ii) iodine-containing olefins; iii) bromine-containing vinyl ethers; iv) iodine-containing vinyl ethers; v) fluorine-containing olefins having a nitrile group; vi) fluorine-containing vinyl ethers having a nitrile group; vii) 1,1,3,3,3-pentafluoropropene (2-HPFP); viii) perfluoro(2-phenoxypropyl vinyl)ether; and ix) non-conjugated dienes.

Brominated cure site monomers may contain other halogens, preferably fluorine. Examples of brominated olefin cure site monomers are CF₂═CFOCF₂CF₂CF₂OCF₂CF₂Br; bromotrifluoroethylene; 4-bromo-3,3,4,4-tetrafluorobutene-1 (BTFB); and others such as vinyl bromide, 1-bromo-2,2-difluoroethylene; perfluoroallyl bromide; 4-bromo-1,1,2-trifluorobutene-1; 4-bromo-1,1,3,3,4,4,-hexafluorobutene; 4-bromo-3-chloro-1,1,3,4,4-pentafluorobutene; 6-bromo-5,5,6,6-tetrafluorohexene; 4-bromoperfluorobutene-1 and 3,3-difluoroallyl bromide. Brominated vinyl ether cure site monomers useful in the invention include 2-bromo-perfluoroethyl perfluorovinyl ether and fluorinated compounds of the class CF₂Br—R_{f}—O—CF═CF₂ (R_{f} is a perfluoroalkylene group), such as CF₂BrCF₂O—CF═CF₂, and fluorovinyl ethers of the class ROCF═CFBr or ROCBr═CF₂ (where R is a lower alkyl group or fluoroalkyl group) such as CH₃OCF═CFBr or CF₃CH₂OCF═CFBr.

Suitable iodinated cure site monomers include iodinated olefins of the formula: CHR═CH—Z—CH₂CHR—I, wherein R is —H or —CH₃; Z is a C₁-C₁₈ (per)fluoroalkylene radical, linear or branched, optionally containing one or more ether oxygen atoms, or a (per)fluoropolyoxyalkylene radical as disclosed in U.S. Pat. No. 5,674,959. Other examples of useful iodinated cure site monomers are unsaturated ethers of the formula: I(CH₂CF₂CF₂)ₙOCF═CF₂ and ICH₂CF₂O[CF(CF₃)CF₂O]ₙCF═CF₂, and the like, wherein n=1-3, such as disclosed in U.S. Pat. No. 5,717,036. In addition, suitable iodinated cure site monomers including iodoethylene, 4-iodo-3,3,4,4-tetrafluorobutene-1(ITFB); 3-chloro-4-iodo-3,4,4-trifluorobutene; 2-iodo-1,1,2,2-tetrafluoro-1-(vinyloxy)ethane; 2-iodo-1-(perfluorovinyloxy)-1,1,-2,2-tetrafluoroethylene; 1,1,2,3,3,3-hexafluoro-2-iodo-1-(perfluorovinyloxy)propane; 2-iodoethyl vinyl ether; 3,3,4,5,5,5-hexafluoro-4-iodopentene; and iodotrifluoroethylene are disclosed in U.S. Pat. No. 4,694,045. Allyl iodide and 2-iodo-perfluoroethyl perfluorovinyl ether are also useful cure site monomers.

Useful nitrile-containing cure site monomers include those of the formulas shown below.

CF₂═CF—O(CF₂)ₙ—CN (VI)

where n=2-12, preferably 2-6;

CF₂═CF—O[CF₂—CF(CF₃)—O]ₙ—CF₂—CF(CF₃)—CN (VII)

where n=0-4, preferably 0-2;

CF₂═CF—[OCF₂CF(CF₃)]ₓ—O—(CF₂)ₙ—CN (VIII)

where x=1-2, and n=1-4; and

CF₂═CF—O—(CF₂)ₙ—O—CF(CF₃)CN (IX)

where n=2-4. Those of formula (VIII) are preferred. Especially preferred cure site monomers are perfluorinated polyethers having a nitrile group and a trifluorovinyl ether group. A most preferred cure site monomer is

CF₂═CFOCF₂CF(CF₃)OCF₂CF₂CN (X)

i.e. perfluoro(8-cyano-5-methyl-3,6-dioxa-1-octene) or 8-CNVE.

Examples of non-conjugated diene cure site monomers include, but are not limited to 1,4-pentadiene; 1,5-hexadiene; 1,7-octadiene; 3,3,4,4-tetrafluoro-1,5-hexadiene; and others, such as those disclosed in Canadian Patent 2,067,891 and European Patent 0784064A1. A suitable triene is 8-methyl-4-ethylidene-1,7-octadiene.

Of the cure site monomers listed above, preferred monomers for situations wherein the fluoroelastomer will be cured with peroxide, include 4-bromo-3,3,4,4-tetrafluorobutene-1 (BTFB); 4-iodo-3,3,4,4-tetrafluorobutene-1 (ITFB); allyl iodide; bromotrifluoroethylene and 8-CNVE. When the fluoroelastomer will be cured with a polyol, 2-HPFP or perfluoro(2-phenoxypropyl vinyl)ether is the preferred cure site monomer. When the fluoroelastomer will be cured with a tetraamine, bis(aminophenol) or bis(thioaminophenol), 8-CNVE is the preferred cure site monomer.

Units of cure site monomer, when present in the fluoroelastomers of this invention, are typically present at a level of 0.05-10 wt. % (based on the total weight of fluoroelastomer), preferably 0.05-5 wt. % and most preferably between 0.05 and 3 wt. %.

Specific fluoroelastomers which may be produced by the process of this invention include, but are not limited to those having at least 58 wt. % fluorine and comprising copolymerized units of i) vinylidene fluoride and hexafluoropropylene; ii) vinylidene fluoride, hexafluoropropylene and tetrafluoroethylene; iii) vinylidene fluoride, hexafluoropropylene, tetrafluoroethylene and 4-bromo-3,3,4,4-tetrafluorobutene-1; iv) vinylidene fluoride, hexafluoropropylene, tetrafluoroethylene and 4-iodo-3,3,4,4-tetrafluorobutene-1; v) vinylidene fluoride, perfluoro(methyl vinyl)ether, tetrafluoroethylene and 4-bromo-3,3,4,4-tetrafluorobutene-1; vi) vinylidene fluoride, perfluoro(methyl vinyl)ether, tetrafluoroethylene and 4-iodo-3,3,4,4-tetrafluorobutene-1; vii) vinylidene fluoride, perfluoro(methyl vinyl)ether, tetrafluoroethylene and 1,1,3,3,3-pentafluoropropene; viii) tetrafluoroethylene, perfluoro(methyl vinyl)ether and ethylene; ix) tetrafluoroethylene, perfluoro(methyl vinyl)ether, ethylene and 4-bromo-3,3,4,4-tetrafluorobutene-1; x) tetrafluoroethylene, perfluoro(methyl vinyl)ether, ethylene and 4-iodo-3,3,4,4-tetrafluorobutene-1; xi) tetrafluoroethylene and propylene; xii) tetrafluoroethylene, propylene and 3,3,3-trifluoropropene; xiii) tetrafluoroethylene, propylene and vinylidene fluoride; xiv) tetrafluoroethylene and perfluoro(methyl vinyl)ether; xv) tetrafluoroethylene, perfluoro(methyl vinyl)ether and perfluoro(8-cyano-5-methyl-3,6-dioxa-1-octene); xvi) tetrafluoroethylene, perfluoro(methyl vinyl)ether and 4-bromo-3,3,4,4-tetrafluorobutene-1; xvii) tetrafluoroethylene, perfluoro(methyl vinyl)ether and 4-iodo-3,3,4,4-tetrafluorobutene-1; and xviii) tetrafluoroethylene, perfluoro(methyl vinyl)ether and perfluoro(2-phenoxypropyl vinyl)ether.

Additionally, iodine-containing endgroups, bromine-containing endgroups or mixtures thereof may optionally be present at one or both of the fluoroelastomer polymer chain ends as a result of the use of chain transfer or molecular weight regulating agents during preparation of the fluoroelastomers. The amount of chain transfer agent, when employed, is calculated to result in an iodine or bromine level in the fluoroelastomer in the range of 0.005-5 wt. %, preferably 0.05-3 wt. %.

Examples of chain transfer agents include iodine-containing compounds that result in incorporation of bound iodine at one or both ends of the polymer molecules. Methylene iodide; 1,4-diiodoperfluoro-n-butane; and 1,6-diiodo-3,3,4,4,tetrafluorohexane are representative of such agents. Other iodinated chain transfer agents include 1,3-diiodoperfluoropropane; 1,6-diiodoperfluorohexane; 1,3-diiodo-2-chloroperfluoropropane; 1,2-di(iododifluoromethyl)-perfluorocyclobutane; monoiodoperfluoroethane; monoiodoperfluorobutane; 2-iodo-1-hydroperfluoroethane, etc. Also included are the cyano-iodine chain transfer agents disclosed European Patent 0868447A1. Particularly preferred are diiodinated chain transfer agents.

Examples of brominated chain transfer agents include 1-bromo-2-iodoperfluoroethane; 1-bromo-3-iodoperfluoropropane; 1-iodo-2-bromo-1,1-difluoroethane and others such as disclosed in U.S. Pat. No. 5,151,492.

Other chain transfer agents suitable for use in the process of this invention include those disclosed in U.S. Pat. No. 3,707,529. Examples of such agents include isopropanol, diethylmalonate, ethyl acetate, carbon tetrachloride, acetone and dodecyl mercaptan.

Cure site monomers and chain transfer agents may be added to the reactor neat or as solutions. In addition to being introduced into the reactor near the beginning of polymerization, quantities of chain transfer agent may be added throughout the entire polymerization reaction period, depending upon the desired composition of the fluoroelastomer being produced, the chain transfer agent being employed, and the total reaction time.

Fluoroelastomer dispersions employed in this invention are manufactured by emulsion polymerization. The emulsion polymerization process may be a continuous, semi-batch or batch process.

In a semi-batch emulsion polymerization process, a gaseous monomer mixture of a desired composition (initial monomer charge) is introduced into a reactor which contains an aqueous solution. The aqueous solution may optionally contain a surfactant. The reactor is typically not completely filled with the aqueous solution, so that a vapor space remains. The aqueous solution comprises a straight chain hydrocarbon phosphate ester surfactant dispersing agent of the type discussed above. Optionally, the aqueous solution may contain a pH buffer, such as a phosphate or acetate buffer for controlling the pH of the polymerization reaction. Instead of a buffer, a base, such as NaOH may be used to control pH. Generally, pH is controlled to between 1 and 7, depending upon the type of fluoroelastomer being prepared. Alternatively, or additionally, pH buffer or base may be added to the reactor at various times throughout the polymerization reaction, either alone or in combination with other ingredients such as polymerization initiator, liquid cure site monomer, additional straight chain hydrocarbon phosphate ester surfactant or chain transfer agent. Also optionally, the initial aqueous solution may contain a water-soluble inorganic peroxide polymerization initiator. In addition, the initial aqueous solution may contain a nucleating agent, such as a fluoroelastomer seed polymer prepared previously, in order to promote fluoroelastomer latex particle formation and thus speed up the polymerization process.

The initial monomer charge contains a quantity of a first monomer of either TFE or VF₂ and one or more additional monomers which are different from the first monomer. The amount of monomer mixture contained in the initial charge is set so as to result in a reactor pressure between 0.5 and 10 MPa.

The monomer mixture is dispersed in the aqueous medium and, optionally, a chain transfer agent may also be added at this point while the reaction mixture is agitated, typically by mechanical stirring. In the initial gaseous monomer charge, the relative amount of each monomer is dictated by reaction kinetics and is set so as to result in a fluoroelastomer having the desired ratio of copolymerized monomer units (i.e. very slow reacting monomers must be present in a higher amount relative to the other monomers than is desired in the composition of the fluoroelastomer to be produced).

The temperature of the semi-batch reaction mixture is maintained in the range of 25° C.-130° C., preferably 50° C.-120° C. Polymerization begins when the initiator either thermally decomposes or reacts with reducing agent and the resulting radicals react with dispersed monomer.

Additional quantities of the gaseous major monomers and cure site monomer (incremental feed) are added at a controlled rate throughout the polymerization in order to maintain a constant reactor pressure at a controlled temperature. The relative ratio of monomers contained in the incremental feed is set to be approximately the same as the desired ratio of copolymerized monomer units in the resulting fluoroelastomer. Thus, the incremental feed contains between 25 to 70 weight percent, based on the total weight of the monomer mixture, of a first monomer of either TFE or VF₂ and 75 to 30 weight percent of one or more additional monomers that are different from the first monomer. Chain transfer agent may also, optionally, be introduced into the reactor at any point during this stage of the polymerization. Typically, additional polymerization initiator is also fed to the reactor during this stage of polymerization. The amount of polymer formed is approximately equal to the cumulative amount of incremental monomer feed. One skilled in the art will recognize that the molar ratio of monomers in the incremental feed is not necessarily exactly the same as that of the desired (i.e. selected) copolymerized monomer unit composition in the resulting fluoroelastomer because the composition of the initial charge may not be exactly that required for the selected final fluoroelastomer composition, or because a portion of the monomers in the incremental feed may dissolve into the polymer particles already formed, without reacting. Polymerization times in the range of from 2 to 30 hours are typically employed in this semi-batch polymerization process.

A continuous emulsion polymerization process differs from the semi-batch process in the following manner. The reactor is completely filled with aqueous solution so that there is no vapor space. Gaseous monomers and solutions of other ingredients such as water-soluble monomers, chain transfer agents, buffer, bases, polymerization initiator, surfactant, etc., are fed to the reactor in separate streams at a constant rate. Feed rates are controlled so that the average polymer residence time in the reactor is generally between 0.2 to 4 hours. Short residence times are employed for reactive monomers, whereas less reactive monomers such as perfluoro(alkyl vinyl)ethers require more time. The temperature of the continuous process reaction mixture is maintained in the range of 25° C.-130° C., preferably 80° C.-120° C. Also, fluoroelastomer latex particles are more readily formed in the continuous process so that a nucleating agent is not typically required in order to start the polymerization reaction.

The polymerization pressure is controlled in the range of 0.5 to 10 MPa, preferably 1 to 6.2 MPa. In a semi-batch process, the desired polymerization pressure is initially achieved by adjusting the amount of gaseous monomers in the initial charge, and after the reaction is initiated, the pressure is adjusted by controlling the incremental gaseous monomer feed. In a continuous process, pressure is adjusted by a back-pressure regulator in the dispersion effluent line. The polymerization pressure is set in the above range because if it is below 1 MPa, the monomer concentration in the polymerization reaction system is too low to obtain a satisfactory reaction rate. In addition, the molecular weight does not increase sufficiently. If the pressure is above 10 MPa, the cost of the required high pressure equipment is very high.

The amount of fluoroelastomer copolymer formed is approximately equal to the amount of incremental feed charged, and is in the range of 10-30 parts by weight of copolymer per 100 parts by weight of aqueous medium, preferably in the range of 20-25 parts by weight of the copolymer. The degree of copolymer formation is set in the above range because if it is less than 10 parts by weight, productivity is undesirably low, while if it is above 30 parts by weight, the solids content becomes too high for satisfactory stirring.

Water-soluble peroxides which may be used to initiate polymerization include, for example, the ammonium, sodium or potassium salts of hydrogen persulfate. In a redox-type initiation, a reducing agent such as sodium sulfite, is present in addition to the peroxide. These water-soluble peroxides may be used alone or as a mixture of two or more types. The amount to be used is selected generally in the range of 0.01 to 0.4 parts by weight per 100 parts by weight of polymer, preferably 0.05 to 0.3. During polymerization some of the fluoroelastomer polymer chain ends are capped with fragments generated by the decomposition of these peroxides.

Surfactants are optionally employed in these processes. Examples of surfactants include perfluorooctanoic acid, sodium octyl sulfonate, and perfluorohexylethylsulfonic acid. However, surfactant is not necessarily required.

Fluoroelastomer gum or crumb is isolated from the fluoroelastomer dispersions by the addition of a polymeric coagulating agent to the dispersion. This coagulating agent comprises at least two onium centers in a water soluble polymer. Onium centers may be part of the main polymer chain or pendant groups off the main polymer chain. The onium atom, Q, may be nitrogen or phosphorus. An onium center is defined as (R₁R₂R₃R₄Q)⁺X⁻, where R₁, R₂, R₃, and R₄ are the same or different alkyl, alkenyl or aryl groups. Up to three R groups (e.g. R₁, R₂, R₃) and Q may be part of a heterocyclic structure. The anion, X, may be any univalent anion such as chloride, bromide, methylsulfonate, etc. Specific examples of water-soluble polymers having at least two onium centers include, but are not limited to poly(diallyldimethylammonium chloride), poly(epichlorohydrin-co-dimethyl amine), poly(acrylamide-co-diallyldimethylammonium chloride), copolymers of (trimethylammonium)ethyl methacrylate such as polyquaternium-5 and polyquaternium-47, poly(vinyl N-methylimidazolium chloride), copolymers of quaternized vinylimidazole such as polyquaternium-16, polyquaternium-46, and polyquaternium-68, poly(N-methyl-2-vinylpyridinium chloride), poly(N-methyl-4-vinylpyridinium chloride), and polyviologen. The nomenclature “polyquaternium-#” is according to the International Nomenclature for Cosmetic Ingredients.

The fluoroelastomers prepared by the process of this invention and curable compositions thereof are useful in many industrial applications including seals, wire coatings, tubing and laminates.

An especially useful curable composition comprises a polyhydroxy curative and a fluoroelastomer prepared by the process of the invention. These curable compositions of the invention contain between 0.1 and 20 parts by weight (preferably 1-3 parts) of polyhydroxy crosslinking agent (or a derivative thereof) per 100 parts fluoroelastomer. Typical polyhydroxy cross-linking agents include di-, tri-, and tetrahydroxybenzenes, naphthalenes, and anthracenes, and bisphenols of the formula

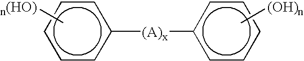

where A is a difunctional aliphatic, cycloaliphatic, or aromatic radical of 1-13 carbon atoms, or a thio, oxy, carbonyl, sulfinyl, or sulfonyl radical; A may optionally be substituted with at least one chlorine or fluorine atom; x is 0 or 1; n is 1 or 2; and any aromatic ring of the polyhydroxylic compound may optionally be substituted with at least one chlorine or fluorine atom, an amino group, a —CHO group, or a carboxyl or acyl radical. Preferred polyhydroxy compounds include hexafluoroisopropylidene-bis(4-hydroxy-benzene) (i.e. bisphenol AF or BPAF); 4,4′-isopropylidene diphenol (i.e. bisphenol A); 4,4′-dihydroxydiphenyl sulfone; and 4,4′-[2,2,2-trifluoro-1-(trifluoromethyl)ethylidene]bis(2-aminophenol) (i.e. diaminobisphenol AF). Referring to the bisphenol formula shown above, when A is alkylene, it can be for example methylene, ethylene, chloroethylene, fluoroethylene, difluoroethylene, propylidene, isopropylidene, tributylidene, heptachlorobutylidene, hepta-fluorobutylidene, pentylidene, hexylidene, and 1,1-cyclohexylidene. When A is a cycloalkylene radical, it can be for example 1,4-cyclohexylene, 2-chloro-1,4-cyclohexylene, cyclopentylene, or 2-fluoro-1,4-cyclohexylene. Further, A can be an arylene radical such as m-phenylene, p-phenylene, o-phenylene, methylphenylene, dimethylphenylene, 1,4-naphthylene, 3-fluoro-1,4-naphthylene, and 2,6-naphthylene. Polyhydroxyphenols of the formula

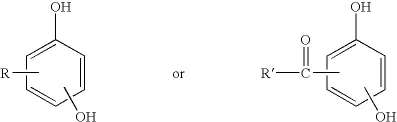

where R is H or an alkyl group having 1-4 carbon atoms or an aryl group containing 6-10 carbon atoms and R′ is an alkyl group containing 1-4 carbon atoms also act as effective crosslinking agents. Examples of such compounds include hydroquinone, catechol, resorcinol, 2-methylresorcinol, 5-methyl-resorcinol, 2-methylhydroquinone, 2,5-dimethylhydroquinone, 2-t-butyl-hydroquinone; and such compounds as 1,5-dihydroxynaphthalene and 2,6-dihydroxynaphthalene.

Additional polyhydroxy curing agents include alkali metal salts of bisphenol anions, quaternary ammonium salts of bisphenol anions, tertiary sulfonium salts of bisphenol anions and quaternary phosphonium salts of bisphenol anions. For example, the salts of bisphenol A and bisphenol AF. Specific examples include the disodium salt of bisphenol AF, the dipotassium salt of bisphenol AF, the monosodium monopotassium salt of bisphenol AF and the benzyltriphenylphosphonium salt of bisphenol AF.

Quaternary ammonium and phosphonium salts of bisphenol anions are discussed in U.S. Pat. Nos. 4,957,975 and 5,648,429. Bisphenol AF salts (1:1 molar ratio) with quaternary ammonium ions of the formula R₁R₂R₃R₄N⁺, wherein R₁-R₄ are C₁-C₈ alkyl groups and at least three of R₁-R₄ are C₃ or C₄ alkyl groups are preferred. Specific examples of these preferred compositions include the 1:1 molar ratio salts of tetrapropyl ammonium-, methyltributylammonium- and tetrabutylammonium bisphenol AF. Such salts may be made by a variety of methods. For instance a methanolic solution of bisphenol AF may be mixed with a methanolic solution of a quaternary ammonium salt, the pH is then raised with sodium methoxide, causing an inorganic sodium salt to precipitate. After filtration, the tetraalkylammonium/BPAF salt may be isolated from solution by evaporation of the methanol. Alternatively, a methanolic solution of tetraalkylammonium hydroxide may be employed in place of the solution of quaternary ammonium salt, thus eliminating the precipitation of an inorganic salt and the need for its removal prior to evaporation of the solution.

In addition, derivatized polyhydroxy compounds such as mono- or diesters, and trimethylsilyl ethers are useful crosslinking agents. Examples of such compositions include, but are not limited to resorcinol monobenzoate, the diacetate of bisphenol AF, the diacetate of sulfonyl diphenol, and the diacetate of hydroquinone.

The curable compositions of the invention typically also contain between 1 to 30 parts by weight (preferably 1 to 7 parts) of an acid acceptor per 100 parts fluoroelastomer. The acid acceptor is typically a strong organic base such as Proton Sponge® (available from Aldrich) or an oxirane, or an inorganic base such as a metal oxide, metal hydroxide, or a mixture of 2 or more of the latter. Metal oxides or hydroxides which are useful acid acceptors include calcium hydroxide, magnesium oxide, lead oxide, zinc oxide and calcium oxide. Calcium hydroxide and magnesium oxide are preferred.

Vulcanization accelerators which may be used in the curable compositions of the invention include tertiary sulfonium salts such as [(C₆H₅)₂S⁺(C₆H₁₃)][Cl]⁻, and [(C₆H₁₃)₂S(C₆H₅)]⁺[CH₃CO₂]⁻ and quarternary ammonium, phosphonium, arsonium, and stibonium salts of the formula R₅R₆R₇R₈Y⁺X⁻ where Y is phosphorous, nitrogen, arsenic, or antimony; R₅, R₆, R₇, and R₈ are individually C₁-C₂₀ alkyl, aryl, aralkyl, alkenyl, and the chlorine, fluorine, bromine, cyano, —OR, and —COOR substituted analogs thereof, with R being C₁-C₂₀ alkyl, aryl, aralkyl, alkenyl, and where X is halide, hydroxide, sulfate, sulfite, carbonate, pentachlorothiophenolate, tetrafluoroborate, hexafluorosilicate, hexafluorophosphate, dimethyl phosphate, and C₁-C₂₀ alkyl, aryl, aralkyl, and alkenyl carboxylates and dicarboxylates. Particularly preferred are benzyltri-phenylphosphonium chloride, benzyltriphenylphosphonium bromide, tetrabutylammonium hydrogen sulfate, tetrabutylammonium hydroxide, tetrapropylammonium hydroxide, tetrabutylammonium bromide, tributylallylphosphonium chloride, tributyl-2-methoxypropylphosphonium chloride, 1,8-diazabicyclo[5.4.0]undec-7-ene, and benzyldiphenyl(dimethylamino)phosphonium chloride. Other useful accelerators include methyltrioctylammonium chloride, methyltributylammonium chloride, tetrapropylammonium chloride, benzyltrioctylphosphonium bromide, benzyltrioctylphosphonium chloride, methyltrioctylphosphonium acetate, tetraoctylphosphonium bromide, methyltriphenylarsonium tetrafluoroborate, tetraphenylstibonium bromide, 4-chlorobenzyltriphenyl phosphonium chloride, 8-benzyl-1,8-diazabicyclo(5.4.0)-7-undecenonium chloride, diphenylmethyltriphenylphosphonium chloride, allyltriphenyl-phosphonium chloride, tetrabutylphosphonium bromide, m-trifluoromethyl-benzyltrioctylphosphonium chloride, and other quaternary compounds disclosed in U.S. Pat. Nos. 5,591,804; 4,912,171; 4,882,390; 4,259,463; 4,250,278 and 3,876,654. The amount of accelerator used is between 0.1 and 20 parts by weight per hundred parts by weight fluoroelastomer. Preferably, 0.5-3.0 parts accelerator per hundred parts fluoroelastomer is used.

### EXAMPLES

### Test Methods

Mooney viscosity, ML (1+10), was determined according to ASTM D1646 with an L (large) type rotor at 121° C., using a preheating time of one minute and rotor operation time of 10 minutes.

Compression sets on O-rings were determined according to (method B) of ASTM D395.

Mooney scorch was determined according to ASTM D1646, small rotor @ 121° C.

Cure characteristics were measured on an Alpha Technologies Moving Disc Rheometer (MDR) according to ASTM D5289

The invention is further illustrated by, but is not limited to, the following examples.

### Example 1

Fluoroelastomer latexes employed in this example were made by the following procedure.

Latex 1. A vinylidene fluoride (VF₂)-hexafluoropropylene (HFP) dipolymer latex was prepared by adding 24000 grams deionized, deoxygenated water to a 33.3 liter stirred reactor. Oxygen was removed by purging with nitrogen, and then the reactor was pressurized to 0.66 MPa gauge with a mixture of 38 weight percent (wt %) VF₂ and 62 wt % HFP at a temperature of 80° C. Polymerization was commenced by adding 550 mL of a 10 wt. % ammonium peroxydisulfate solution. Reactor pressure was maintained at 0.66 MPa gauge by feeding a mixture of 60 wt % VF₂ and 40 wt % HFP to the reactor. After 6000 grams of the 60 wt % VF₂/40 wt % HFP mixture has been fed to the reactor, polymerization was stopped by depressurizing the reactor and cooling it. 30,418 grams of a 19.51 wt. % solids latex were obtained.

Latex 2. A second VF₂/HFP dipolymer latex was prepared in a similar to manner to that of Latex 1 except the reactor pressure was maintained at 0.62 MPa. 30,610 grams of a 19.47% solids latex were obtained.

The two VF₂/HFP dipolymer latexes were blended together. Several 5000-gram portions were weighed out, diluted to 15 wt. % solids with 1667 grams deionized water, and then coagulated by dripping in a coagulant solution according to Table 1. Sample 1 was coagulated according to the process of the invention. Control Samples A-G were coagulating according to processes of the prior art.

TABLE 1

| Sample | Coagulant |
|---|---|
| 1 | 1 wt. % poly(diallyldimethyl ammonium chloride) |
| Control A | 1 wt. % tetraethyl ammonium chloride |
| Control B | 1 wt. % tetrabutyl ammonium chloride |
| Control C | 1 wt. % stearyl trimethyl ammonium chloride |
| Control D | 1 wt. % benzyl triphenyl phosphonium chloride |
| Control E | tetraethylpentaamine |
| Control F | xylylene diamine |
| Control G | 1 wt. % calcium nitrate |

In Samples 1, A-D and G, a slurry of polymer in water formed upon addition of the coagulant solution. A minimum of coagulant solution was added until a clear supernatant serum was obtained.

In Samples E and F, an undesirable polymer gel formed upon addition of the coagulant. No further coagulant was added after gelation of the latex and the gel was broken up with stirring.

The polymers resulting from Samples 1 and A-G were washed with 5000 grams deionized water after coagulation and dried at 70° C. Polymers were then milled with compounding ingredients according to the following recipe.

| Ingredient | Parts per hundred rubber |
|---|---|
| Polymer | 100.0 |
| Bisphenol AF | 2.04 |
| Benzyl triphenyl phosphonium chloride | 0.51 |
| Elastomag 170 (magnesium oxide) | 3.08 |
| Calcium hydroxide (HP-XL) | 6.15 |

The Mooney scorch at 121° C. of the compounded polymers was then measured.

| | Minutes to a | | |
|---|---|---|---|
| Polymer | 2 pt rise | 5 pt rise | 10 pt rise |
| 1 | >30 | >30 | >30 |
| Control A | 12.6 | 14.1 | 15.3 |
| Control B | 17.2 | 19.4 | 21.0 |
| Control C | 4.2 | 4.7 | 5.1 |
| Control D | 17.4 | 19.6 | 21.4 |
| Control E | 16.4 | 24.9 | >30 |
| Control F | 13.8 | 20.3 | 28.4 |
| Control G | >30 | >30 | >30 |

These Mooney scorch data demonstrate that the polymeric coagulant provides desirably long protection against scorch and premature crosslinking during fabrication.

Curing characteristics of the compounded polymers was then measured using a moving disk rheometer at 177° C.

| Polymer | M-L (dN-m) | ts-2 (min) | t′50 (min) | t′95 (min) | M-H (dN-m) |
|---|---|---|---|---|---|
| 1 | 0.5 | 1.9 | 2.3 | 5.6 | 9.6 |
| A | 0.5 | 0.7 | 0.9 | 4.3 | 10.9 |
| B | 0.5 | 0.8 | 0.9 | 2.9 | 11.1 |
| C | 0.9 | 0.5 | 0.6 | 5.7 | 9.1 |
| D | 0.5 | 0.9 | 1.0 | 2.2 | 10.5 |
| E | 0.5 | 3.6 | 4.3 | 9.2 | 9.9 |
| F | 0.5 | 3.3 | 3.9 | 7.9 | 10.2 |
| G | 0.5 | 3.2 | 3.7 | 7.4 | 10.9 |

Compression set (O-rings) of cured (press cured 7 minutes @ 177° C. and post-cured in an air oven for 16 hours @ 232° C.) polymers was then determined.

| Polymer | C/S, %, 70 hr @ 200° C. |
|---|---|
| 1 | 22 |
| Control A | 29 |
| Control B | 26 |
| Control C | 58 |
| Control D | 28 |
| Control E | 29 |
| Control F | 28 |
| Control G | 17 |

This demonstrates that isolation of the polymer according to the invention results in a polymer that is not excessively scorchy, yet displays good compression set.

### Example 2

A VF₂/HFP copolymer fluoroelastomer was prepared by a continuous emulsion polymerization process, carried out at 115° C. in a well-stirred 4.0-liter stainless steel liquid full reaction vessel. An aqueous solution, consisting of 4.37 g/hour (g/h) ammonium persulfate initiator, 5.24 g/h disodium phosphate heptahydrate, 3.37 g/h sodium octyl sulfonate, and 1.50 g/h isopropanol chain transfer agent in deionized water, was fed to the reactor at a rate of 10 L/hour. The reactor was maintained at a liquid-full level at a pressure of 6.2 MPa by means of a backpressure control valve in the effluent line. After 30 minutes, polymerization was initiated by introduction of a gaseous monomer mixture consisting of 1537 g/h vinylidene fluoride (VF₂), and 1151 g/h hexafluoropropylene (HFP), fed through a diaphragm compressor. After 2.0 hours, collection of effluent dispersion was begun and collection continued for 6 hours. The effluent polymer latex, which had a pH of 3.24 and contained 25.5 wt. % solids, was separated from residual monomers in a degassing vessel at atmospheric pressure. Fluoroelastomer polymer was isolated as described below.
Polymer 2. This polymer was coagulated by a process of the invention. 10.0 kg latex was mixed with 3300 grams deionized water. 30.5 grams of a 6 wt. % poly(diallyldimethylammonium chloride) solution was dripped into the diluted latex to form a coagulum. The coagulated polymer was allowed to settle, supernatant serum was removed, and the polymer was washed by reslurrying in 9.0 kg portions of deionized water four times before filtering. The wet crumb was dried in an air oven at approximately 50°-65° C. to a moisture content of less than 1 wt. %. The product, comprised of 61 wt. % VF₂ units and 39 wt. % HFP units, was an amorphous elastomer having a glass transition temperature of −19.4° C., as determined by differential scanning calorimetry (heating mode, 10° C./minute, inflection point of transition). Inherent viscosity of the elastomer was 1.05 dL/g, measured at 30° C. in methyl ethyl ketone, and Mooney viscosity, ML(1+10) at 121° C., was 82.5.
Polymer H. This polymer was coagulated by a prior art process. 10.0 kg latex was mixed with 3300 grams deionized water. 1450 grams of a 6 wt. % tetraethylammonium acetate solution was dripped into the diluted latex to form a coagulum. The coagulated polymer was allowed to settle, supernatant serum was removed, and the polymer was washed by reslurrying in 9.0 kg portions of deionized water four times before filtering. The wet crumb was dried in an air oven at approximately 50°-65° C. to a moisture content of less than 1 wt. %. The product, comprised of 61 wt. % VF₂ units and 39 wt. % HFP units, was an amorphous elastomer having a glass transition temperature of −18.8° C., as determined by differential scanning calorimetry (heating mode, 10° C./minute, inflection point of transition). Inherent viscosity of the elastomer was 1.05 dL/g, measured at 30° C. in methyl ethyl ketone, and Mooney viscosity, ML(1+10) at 121° C., was 88.8.

### Example 3

A VF₂/HFP/TFE copolymer fluoroelastomer was prepared by a continuous emulsion polymerization process, carried out at 110° C. in a well-stirred 2.0-liter stainless steel liquid full reaction vessel. An aqueous solution, consisting of 2.16 g/hour (g/h) ammonium persulfate initiator, 0.87 g/h sodium hydroxide, 1.31 g/h sodium octyl sulfonate, and 0.98 g/h isopropanol chain transfer agent in deionized water, was fed to the reactor at a rate of 4.8 L/hour. The reactor was maintained at a liquid-full level at a pressure of 6.2 MPa by means of a backpressure control valve in the effluent line. After 30 minutes, polymerization was initiated by introduction of a gaseous monomer mixture consisting of 395 g/h vinylidene fluoride (VF₂), 507 g/h hexafluoropropylene (HFP), and 309 g/h tetrafluoroethylene (TFE) fed through a diaphragm compressor. After 2.0 hours, collection of effluent dispersion was begun and collection continued for 5 hours. The effluent polymer latex, which had a pH of 3.15 and contained 18.2 wt. % solids, was separated from residual monomers in a degassing vessel at atmospheric pressure.

A coagulation process of the invention was utilized to isolate the fluoroelastomer. Latex was diluted to 15 wt. % solids by addition of deionized water. A coagulum was formed by addition of a 1 wt. % poly(diallyidimethylammonium chloride) solution at the ratio of 15 grams solution to 1 kg diluted latex. The resulting wet crumb was dried in an air oven at approximately 50°-65° C. to a moisture content of less than 1 wt. %. The product, comprised of 36 wt. % VF₂ units, 36 wt. % HFP units, and 28 wt. % TFE units, was an amorphous elastomer having a glass transition temperature of −6.6° C., as determined by differential scanning calorimetry (heating mode, 10° C./minute, inflection point of transition). Inherent viscosity of the elastomer was 0.49 dL/g, measured at 30° C. in methyl ethyl ketone, and Mooney viscosity, ML(1+10) at 121° C., was 57.5.

### Example 4

A VF₂/HFP copolymer fluoroelastomer was prepared by a continuous emulsion polymerization process, carried out at 115° C. in a well-stirred 4.0-liter stainless steel liquid full reaction vessel. An aqueous solution, consisting of 4.37 g/hour (g/h) ammonium persulfate initiator, 10.48 g/h disodium phosphate heptahydrate, 2.69 g/h sodium octyl sulfonate, and 4.20 g/h isopropanol chain transfer agent in deionized water, was fed to the reactor at a rate of 10 L/hour. The reactor was maintained at a liquid-full level at a pressure of 6.2 MPa by means of a backpressure control valve in the effluent line. After 30 minutes, polymerization was initiated by introduction of a gaseous monomer mixture consisting of 1537 g/h vinylidene fluoride (VF₂), and 1151 g/h hexafluoropropylene (HFP), fed through a diaphragm compressor. After 2.0 hours, collection of effluent dispersion was begun and collection continued for 6 hours. The effluent polymer latex, which had a pH of 4.58 and contained 20.6 wt. % solids, was separated from residual monomers in a degassing vessel at atmospheric pressure.

A coagulation process of the invention was utilized to isolate the fluoroelastomer. 10.0 kg of latex was diluted to 15 wt. % solids by addition of deionized water. A coagulating solution was prepared by dissolving 10 grams Superfloc™ C-577 (a 50% A.I. copolymer of epichlorohydrin and dimethyl amine) in 490 grams deionized water to form a 1 wt. % solution. The coagulating solution was added dropwise to the diluted latex. Upon addition of 178 grams of coagulating solution, the polymer had formed a slurry with clear supernatant. The aqueous phase was removed from the slurry and the resulting wet crumb was dried in an air oven at approximately 50°-65° C. to a moisture content of less than 1 wt. %. The product, comprised of 60 wt. % VF₂ units, and 40 wt. % HFP units, was an amorphous elastomer having a glass transition temperature of −19.2° C., as determined by differential scanning calorimetry (heating mode, 10° C./minute, inflection point of transition). Inherent viscosity of the elastomer was 0.66 dL/g, measured at 30° C. in methyl ethyl ketone, and Mooney viscosity, ML(1+10) at 121° C., was 34.2.

What is claimed is:

1. A coagulation process for the production of fluoroelastomers, said fluoroelastomers having at least 53 weight percent fluorine, said process comprising:
(A) providing an aqueous dispersion comprising a fluoroelastomer, said fluoroelastomer comprising copolymerized units of at least two copolymerizable monomers wherein a first monomer is present in an amount between 25 and 70 weight percent, based on total weight of said fluoroelastomer, said first monomer selected from the group consisting of vinylidene fluoride and tetrafluoroethylene; and
(B) adding to said aqueous dispersion an aqueous solution of a water-soluble polymer having at least 2 quaternary onium centers thereby coagulating said fluoroelastomer.

2. The coagulation process of claim 1 wherein said water-soluble polymer having at least 2 quaternary onium centers is selected from the group consisting of poly(diallyldimethylammonium chloride), poly(epichlorohydrin-co-dimethyl amine), poly(acrylamide-co-diallyldimethylammonium chloride), polyquaternium-5 and polyquaternium-47, poly(vinyl N-methylimidazolium chloride), polyquaternium-16, polyquaternium-46, and polyquaternium-68, poly(N-methyl-2-vinylpyridinium chloride), poly(N-methyl-4-vinylpyridinium chloride), and polyviologen.

3. The coagulation process of claim 1 wherein said fluoroelastomer comprises copolymerized units selected from the group consisting of i) vinylidene fluoride and hexafluoropropylene; ii) vinylidene fluoride, hexafluoropropylene and tetrafluoroethylene; iii) vinylidene fluoride, hexafluoropropylene, tetrafluoroethylene and 4-bromo-3,3,4,4-tetrafluorobutene-1; iv) vinylidene fluoride, hexafluoropropylene, tetrafluoroethylene and 4-iodo-3,3,4,4-tetrafluorobutene-1; v) vinylidene fluoride, perfluoro(methyl vinyl)ether, tetrafluoroethylene and 4-bromo-3,3,4,4-tetrafluorobutene-1; vi) vinylidene fluoride, perfluoro(methyl vinyl)ether, tetrafluoroethylene and 4-iodo-3,3,4,4-tetrafluorobutene-1; vii) vinylidene fluoride, perfluoro(methyl vinyl)ether, tetrafluoroethylene and 1,1,3,3,3-pentafluoropropene; viii) tetrafluoroethylene, perfluoro(methyl vinyl)ether and ethylene; ix) tetrafluoroethylene, perfluoro(methyl vinyl)ether, ethylene and 4-bromo-3,3,4,4-tetrafluorobutene-1; x) tetrafluoroethylene, perfluoro(methyl vinyl)ether, ethylene and 4-iodo-3,3,4,4-tetrafluorobutene-1; xi) tetrafluoroethylene and propylene; xii) tetrafluoroethylene, propylene and 3,3,3-trifluoropropene; xiii) tetrafluoroethylene, propylene and vinylidene fluoride; xiv) tetrafluoroethylene and perfluoro(methyl vinyl)ether; xv) tetrafluoroethylene, perfluoro(methyl vinyl)ether and perfluoro(8-cyano-5-methyl-3,6-dioxa-1-octene); xvi) tetrafluoroethylene, perfluoro(methyl vinyl)ether and 4-bromo-3,3,4,4-tetrafluorobutene-1; xvii) tetrafluoroethylene, perfluoro(methyl vinyl)ether and 4-iodo-3,3,4,4-tetrafluorobutene-1; and xviii) tetrafluoroethylene, perfluoro(methyl vinyl)ether and perfluoro(2-phenoxypropyl vinyl)ether.

4. A fluoroelastomer made by a process comprising:
(A) providing an aqueous dispersion comprising a fluoroelastomer, said fluoroelastomer comprising copolymerized units of at least two copolymerizable monomers wherein a first monomer is present in an amount between 25 and 70 weight percent, based on total weight of said fluoroelastomer, said first monomer selected from the group consisting of vinylidene fluoride and tetrafluoroethylene; and
(B) adding to said aqueous dispersion an aqueous solution of a water-soluble polymer having at least 2 quaternary onium centers thereby coagulating said fluoroelastomer.

5. The fluoroelastomer of claim 4 wherein said water-soluble polymer having at least 2 quaternary onium centers is selected from the group consisting of poly(diallyldimethylammonium chloride), poly(epichlorohydrin-co-dimethyl amine), poly(acrylamide-co-diallyldimethylammonium chloride), polyquaternium-5 and polyquaternium-47, poly(vinyl N-methylimidazolium chloride), polyquaternium-16, polyquaternium46, and polyquaternium-68, poly(N-methyl-2-vinylpyridinium chloride), poly(N-methyl-4-vinylpyridinium chloride), and polyviologen.

6. The fluoroelastomer of claim 4 wherein said fluoroelastomer comprises copolymerized units selected from the group consisting of i) vinylidene fluoride and hexafluoropropylene; ii) vinylidene fluoride, hexafluoropropylene and tetrafluoroethylene; iii) vinylidene fluoride, hexafluoropropylene, tetrafluoroethylene and 4-bromo-3,3,4,4-tetrafluorobutene-1; iv) vinylidene fluoride, hexafluoropropylene, tetrafluoroethylene and 4-iodo-3,3,4,4-tetrafluorobutene-1; v) vinylidene fluoride, perfluoro(methyl vinyl)ether, tetrafluoroethylene and 4-bromo-3,3,4,4-tetrafluorobutene-1; vi) vinylidene fluoride, perfluoro(methyl vinyl)ether, tetrafluoroethylene and 4-iodo-3,3,4,4-tetrafluorobutene-1; vii) vinylidene fluoride, perfluoro(methyl vinyl)ether, tetrafluoroethylene and 1,1,3,3,3-pentafluoropropene; viii) tetrafluoroethylene, perfluoro(methyl vinyl)ether and ethylene; ix) tetrafluoroethylene, perfluoro(methyl vinyl)ether, ethylene and 4-bromo-3,3,4,4-tetrafluorobutene-1; x) tetrafluoroethylene, perfluoro(methyl vinyl)ether, ethylene and 4-iodo-3,3,4,4-tetrafluorobutene-1; xi) tetrafluoroethylene and propylene; xii) tetrafluoroethylene, propylene and 3,3,3-trifluoropropene; xiii) tetrafluoroethylene, propylene and vinylidene fluoride; xiv) tetrafluoroethylene and perfluoro(methyl vinyl)ether; xv) tetrafluoroethylene, perfluoro(methyl vinyl)ether and perfluoro(8-cyano-5-methyl-3,6-dioxa-1-octene); xvi) tetrafluoroethylene, perfluoro(methyl vinyl)ether and 4-bromo-3,3,4,4-tetrafluorobutene-1; xvii) tetrafluoroethylene, perfluoro(methyl vinyl)ether and 4-iodo-3,3,4,4-tetrafluorobutene-1; and xviii) tetrafluoroethylene, perfluoro(methyl vinyl)ether and perfluoro(2-phenoxypropyl vinyl)ether.

7. A curable composition comprising:
(A) a polyhydroxy curative; and
(B) a fluoroelastomer made by a process comprising (i) providing an aqueous dispersion comprising a fluoroelastomer, said fluoroelastomer comprising copolymerized units of at least two copolymerizable monomers wherein a first monomer is present in an amount between 25 and 70 weight percent, based on total weight of said fluoroelastomer, said first monomer selected from the group consisting of vinylidene fluoride and tetrafluoroethylene; and
(ii) adding to said aqueous dispersion an aqueous solution of a water-soluble polymer having at least 2 quaternary onium centers thereby coagulating said fluoroelastomer.

8. The curable composition of claim 7 wherein said water-soluble polymer having at least 2 quaternary onium centers is selected from the group consisting of poly(diallyldimethylammonium chloride), poly(epichlorohydrin-co-dimethyl amine), poly(acrylamide-co-diallyldimethylammonium chloride), polyquaternium-5 and polyquaternium-47, poly(vinyl N-methylimidazolium chloride), polyquaternium-16, polyquaternium-46, and polyquaternium-68, poly(N-methyl-2-vinylpyridinium chloride), poly(N-methyl-4-vinylpyridinium chloride), and polyviologen.

9. The curable composition of claim 7 wherein said fluoroelastomer comprises copolymerized units selected from the group consisting of i) vinylidene fluoride and hexafluoropropylene; ii) vinylidene fluoride, hexafluoropropylene and tetrafluoroethylene; iii) vinylidene fluoride, hexafluoropropylene, tetrafluoroethylene and 4-bromo-3,3,4,4-tetrafluorobutene-1; iv) vinylidene fluoride, hexafluoropropylene, tetrafluoroethylene and 4-iodo-3,3,4,4-tetrafluorobutene-1; v) vinylidene fluoride, perfluoro(methyl vinyl)ether, tetrafluoroethylene and 4-bromo-3,3,4,4-tetrafluorobutene-1; vi) vinylidene fluoride, perfluoro(methyl vinyl)ether, tetrafluoroethylene and 4-iodo-3,3,4,4-tetrafluorobutene-1; vii) vinylidene fluoride, perfluoro(methyl vinyl)ether, tetrafluoroethylene and 1,1,3,3,3-pentafluoropropene; viii) tetrafluoroethylene, perfluoro(methyl vinyl)ether and ethylene; ix) tetrafluoroethylene, perfluoro(methyl vinyl)ether, ethylene and 4-bromo-3,3,4,4-tetrafluorobutene-1; x) tetrafluoroethylene, perfluoro(methyl vinyl)ether, ethylene and 4-iodo-3,3,4,4-tetrafluorobutene-1; xi) tetrafluoroethylene and propylene; xii) tetrafluoroethylene, propylene and 3,3,3-trifluoropropene; xiii) tetrafluoroethylene, propylene and vinylidene fluoride; xiv) tetrafluoroethylene and perfluoro(methyl vinyl)ether; xv) tetrafluoroethylene, perfluoro(methyl vinyl)ether and perfluoro(8-cyano-5-methyl-3,6-dioxa-1-octene); xvi) tetrafluoroethylene, perfluoro(methyl vinyl)ether and 4-bromo-3,3,4,4-tetrafluorobutene-1; xvii) tetrafluoroethylene, perfluoro(methyl vinyl)ether and 4-iodo-3,3,4,4-tetrafluorobutene-1; and xviii) tetrafluoroethylene, perfluoro(methyl vinyl)ether and perfluoro(2-phenoxypropyl vinyl)ether.

10. The curable composition of claim 7 wherein said polyhydroxy curative is selected from the group consisting of hexafluoroisopropylidene-bis(4-hydroxybenzene) and 4,4′-[2,2,2-trifluoro-1-(trifluoromethyl)ethylidene]bis(2-aminophenol).

11. The curable composition of claim 7 further comprising C) an acid acceptor and D) a vulcanization accelerator.
